(19) United States
(12) Patent Application Publication
(10) Pub. No.: US 2009/0244404 A1
(43) Pub. Date: Oct. 1, 2009

(54) DIGITAL VIDEO RECORDER-INTEGRATED DISPLAY DEVICE WITH PICTURE-IN-PICTURE FUNCTION

(76) Inventor: Sang-yeol PARK, Seongnam-si (KR)

Correspondence Address: MCNEELY BODENDORF LLP, P.O. BOX 34175, WASHINGTON, DC, 20043, US

(21) Appl. No.: 12/413,620

(22) Filed: Mar. 30, 2009

(30) Foreign Application Priority Data
Mar. 31, 2008 (KR) 10-2008-0029889
Apr. 30, 2008 (KR) 10-2008-0040513
May 30, 2008 (KR) 10-2008-0051093

(51) Int. Cl. H04N 5/66; H04N 5/45; H04N 7/26

(52) U.S. Cl. 348/739; 348/565; 386/124; 386/E05.001

(57) ABSTRACT

A digital video recorder (DVR)-integrated display device with a picture-in-picture function is provided. The digital video recorder (DVR)-integrated display device includes an image multiplexing unit outputting an image frame generated by multiplexing an image signal from each of a plurality of cameras or an image frame selected from images from the respective cameras, a recording/reproduction control unit controlling recording or displaying of an image frame output from the image multiplexing unit, an output image generating unit outputting the image frame together with a particular image selected by a user operation in a picture-in-picture (PIP) format, and a control unit comprehensively controlling elements of the display device.

### CROSS-REFERENCE TO RELATED APPLICATIONS

This application claims priorities from and the benefits of Korean Patent Application Nos. 10-2008-29889, filed on Mar. 31, 2008, 10-2008-40513, filed on Apr. 30, 2008, and 10-2008-51093, filed on May 30, 2008, the disclosure of each of which is incorporated herein in its entirety by reference.

### BACKGROUND

1. Field

The following description relates to a video monitoring apparatus using a digital video recorder (DVR), and more particularly, to a DVR-integrated display device which outputs various types of images including a monitoring image of a DVR in a picture-in-picture (PIP) format.

2. Description of the Related Art

A conventional digital video recorder (DVR)-integrated display device is a recording device that compresses, records and stores digital images in hard disk built in a recorder and reproduces the stored digital images from the hard disk, like a computer. The DVR device is widely used as a security device in public places such as department stores, public institutions, public facilities, and convenience stores, as well as in banks and securities firms.

However, the conventional DVR device only displays images taken by a surveillance camera on a monitor. If an administrator who monitors the images taken by the surveillance camera does another activity (e.g. watches TV) simultaneously, the administrator cannot focus on monitoring the images from the surveillance camera. Also, if the administrator wants to do both activities, i.e., monitoring and watching TV, at the same time, two separate monitors are required—one connected to the DVR and another for watching TV.

Recently, LCD display devices installed in public places provide advertising contents using a variety of methods. For example, LCD displays are installed in public transportation sites such as subway stations to provide services (e.g., weather forecast and stock information) as picture frames.

Since the conventional LCD displays do not show images taken by a surveillance camera of a DVR device, subway security officers cannot rapidly respond to vandalization of the high-priced LCD displays.

### SUMMARY

Accordingly, there is disclosed a display device that simultaneously provides an image from a surveillance camera and a different type of image, allowing real-time monitoring and carrying out of an additional activity.

Furthermore, there is disclosed a display device that provides various types of advertising contents along with images taken by a surveillance camera, which can be monitored in real time.

According to another aspect, there is disclosed a digital video recorder (DVR)-integrated display device with a picture-in-picture function, including an image multiplexing unit outputting an image frame generated by multiplexing an image signal from each of a plurality of cameras or an image frame selected from images from the respective cameras, a recording/reproduction control unit controlling recording or displaying of an image frame output from the image multiplexing unit, an output image generating unit outputting the image frame together with a particular image selected by a user operation in a picture-in-picture (PIP) format, and a control unit comprehensively controlling elements of the display device.

The recording/reproduction control unit may include an encoder encoding the image frame received from the image multiplexing unit, an image storage unit storing the encoded image frame, a decoder decoding the image frame stored in the image storage unit, a format converting unit converting the image frame received from the image multiplexing unit or the image frame decoded by the decoder into a standard format and outputting the converted image frame to the output image generating unit.

The DVR-integrated display device may further include a picture frame output unit including an interface unit, a controller recognizing a memory through the interface unit and controlling an input, and a picture frame decoder decoding picture frame data of the memory and outputting the decoded data to the output image generating unit.

The DVR-integrated display device may further include an external image output unit, when an external image is input, determining whether the input external image is an analog image or a digital image, and when it is determined that the input external image is an analog image, converting the analog image into the digital image and outputting the converted digital image to the output image generating unit, wherein the external image is a computer image or an image received by a television tuner.

The DVR-integrated display device may further include an event detecting unit detecting an abnormal event and transmitting an event detection signal to the control unit, wherein the output image generating unit outputs a particular image selected by the user, stops outputting the particular image upon detection of the abnormal event, and outputs an image frame output from the image multiplexing unit on the monitor in full view.

The output image generating unit may output the particular image selected by the user as a primary display, output the image frame output from the image multiplexing unit as a secondary display, and, when the event detecting unit detects an abnormal event, output the image frame as the primary display and output the selected particular image as the secondary display.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a block diagram of a digital video recorder (DVR)-integrated display device having a picture-in-picture (PIP) function according to an exemplary embodiment.

FIG. 2 is a block diagram of an image multiplexing unit according to an exemplary embodiment.

FIG. 3 is a block diagram of a recording/reproduction control unit according to an exemplary embodiment.

FIG. 4 is a block diagram of a picture frame output unit according to an exemplary embodiment.

FIG. 5 is a block diagram of an output image generating unit according to an exemplary embodiment.

### DETAILED DESCRIPTION

The following detailed description is provided to assist the reader in gaining a comprehensive understanding of the methods, apparatuses and/or systems described herein. Accordingly, various changes, modifications, and equivalents of the systems, apparatuses and/or methods described herein will suggest themselves to those of ordinary skill in the art. Also, descriptions of well-known functions and constructions are omitted to increase clarity and conciseness.

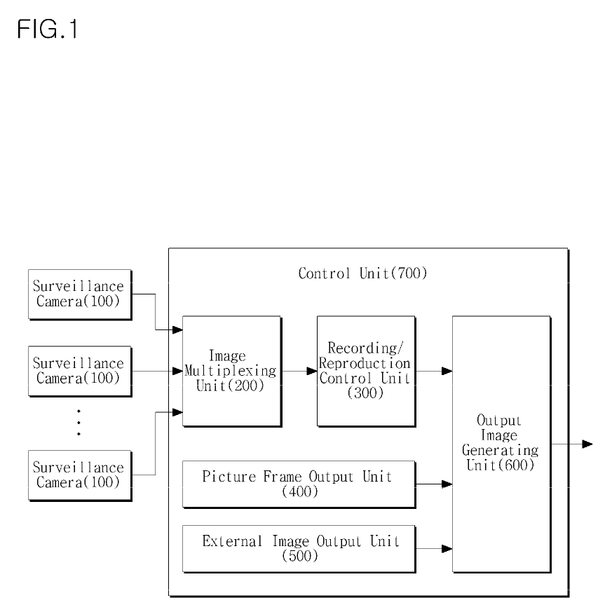

FIG. 1 is a block diagram of a digital video recorder (DVR)-integrated display device having a picture-in-picture (PIP) function according to an exemplary embodiment.

Referring to FIG. 1, the DVR-integrated display device includes a plurality of surveillance cameras 100, an image multiplexing unit 200, a recording/reproduction control unit 300, a picture frame output unit 400, an external image output unit 500, an output image generating unit 600, and a control unit 700.

The plurality of surveillance cameras 100 are installed in particular areas to be monitored and take pictures of the areas. Thus, an administrator can monitor the areas by pictures taken by the surveillance cameras through a monitor in real time.

The image multiplexing unit 200 multiplexes a visual signal output from each surveillance camera 100, and outputs a multiplexed image frame or an image frame selected by a user from the visual signals output from the plurality of surveillance cameras 100.

The recording/reproduction control unit 300 records an image frame output from the image multiplexing unit 200, reproduces the image frame later, or processes the image frame to be displayed in real time.

The picture frame output unit 400 reads data stored in a memory and outputs the data as a picture frame. Various advertising contents are stored in the memory and output as picture frames from the picture frame output unit 400.

When an external image is input to the external image output unit 500, the external image output unit 500 determines whether the external image is an analog image or a digital image. When it is determined that the external image is an analog image, the external image output unit 500 converts the input analog image into a digital image and outputs the converted digital image to the output image generating unit 600. The analog image or digital image input from the exterior may be a computer image or an image from a television tuner.

The output image generating unit 600 creates a composite PIP picture of an image frame output from the recording/reproduction control unit 300 and an image selected by a user and displays the composite PIP picture. That is, the output image generating unit 600 creates a PIP composite image frame with either the picture frame output from the picture frame output unit 400 or an external image output from the external image output unit 500 according to a user operation and displays the composite PIP picture.

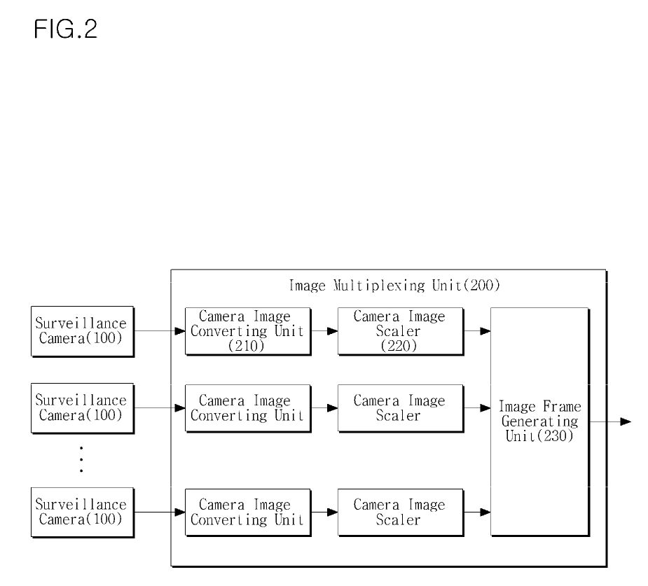

The control unit 700 controls the entire display device which includes the image multiplexing unit 200, the recording/reproduction control unit 300, the picture frame output unit 400, the external image output unit 500 and the output image generating unit 600. The control unit may control operations of other elements by use of a serial bus such as an integrated circuit (I²C) bus. The I²C bus, which is also referred to as an Inter-IC bus, is a two-wire bidirectional serial bus that provides a communication link between integrated circuits. Below, each element in FIG. 1 will be described in detail with reference to FIGS. 2 to 5.

FIG. 2 is a block diagram of the image multiplexing unit 200 according to an exemplary embodiment. As shown in FIG. 2, the image multiplexing unit 200 which multiplexes images output from the respective surveillance cameras 100 or generates a camera image as an image frame includes a camera image converting unit 210, a camera image scaler 220, and an image frame generating unit 230.

The camera image converting unit 210 converts a corresponding image output from each of the surveillance cameras 100 into a digital image in accordance with a standard format. For example, the camera image converting unit 210 may be a national television system committee (NTSC) decoder that converts an analog signal output from each of the surveillance cameras 100 into a digital signal.

The camera image scaler 220 adjusts the number of vertical and/or horizontal scanning lines of each digital image converted by the camera image converting unit 210 in accordance with an output format. For example, when an image from a surveillance camera 100 is displayed in full screen, or when a resolution of an image of the surveillance camera 100 is the same as a resolution of a monitor or a storage format, the camera image scaler 220 outputs the image from the surveillance camera 100 intact. However, when a screen divided into four sections is implemented on the monitor, the camera image scaler 220 interpolates and/or decimates the input image to reduce a resolution of the image from the surveillance camera 100 to a quarter of the original resolution. According to an operation mode, the camera image scaler 220 allows a monitor screen to be divided into a single section, two sections, four sections, eight sections, and so on to display a number of images from the plurality of surveillance cameras 100 in each divided section. The visual signal from each of the surveillance cameras 100 may be processed by the corresponding camera image converting unit 210 and the camera scaler 220.

The image frame generating unit 230 combines digital images that have been scaled by the camera image scaler 220 according to the operation mode, or generates an image frame from a selected digital image. The image frame generating unit 230 combines the digital images frame by frame such that the digital image generated by each of the camera image scalers 220 is output at a designated location on the monitor screen. Accordingly, each digital image is multiplexed by the frame image generating unit 230, or only the specific digital image is generated as an image frame to be output on the monitor screen.

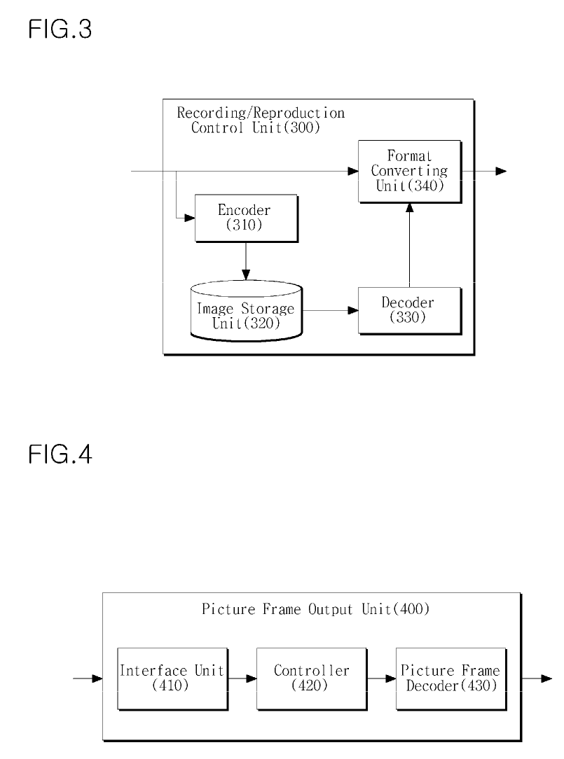

FIG. 3 is a block diagram of the recording/reproduction control unit 300 according to an exemplary embodiment. As shown in FIG. 3, the recording/reproduction control unit 300 includes an encoder 310, an image storage unit 320, a decoder 330, and a format converting unit 340.

The encoder 310 encodes the image frame output from the image frame generating unit 230 according to an image compression standard such as MPEG (moving picture experts group) 4. MPEG4, which is audio-visual (AV) data compression technology enabling implementation of bidirectional multimedia, is a standard encoding image compression method that encodes the visual signal based on image contents. However, the type of image compression method is not limited to MPEG4, and other compression methods such as wavelet and H.264 can be employed.

The image storage unit 320 may be a non-volatile memory that retains data even when the power is off. Examples of the non-volatile memory include ROM (read only memory), Flash memory, and hard disk. The image storage unit 320 is a non-volatile memory that stores the image frame encoded by the encoder 310.

The decoder 330, which decompresses the compressed image, restores the image frame stored in the image storage unit 320. Such a decoder 330 is well-known technology and thus will not be described in detail.

The format converting unit 340 converts the image frame restored by the decoder 330 in accordance with a standard output format. Also, the format converting unit 340 converts a combined image frame or a selected image frame, each of which is output from the image frame generating unit 230, in accordance with a standard output format. That is, the format converting unit 340 converts the format of the image frame to output the visual signal in accordance with a standard output format such as RGB or a composite signal (Vcom). Then, the image frame converted by the format converting unit 340 is output through the output image generating unit 600 to a picture frame type liquid crystal display (LCD) or a monitor screen, together with a picture frame output from the picture frame output unit 400 or an external image output from the external image output unit 500, by a PIP technique.

FIG. 4 is a block diagram of the picture frame output unit 400 according to an exemplary embodiment. As shown in FIG. 4, the picture frame output unit 400 includes an interface unit 410, a controller 420, and a picture frame decoder 430.

The interface unit 410 can establish communication with the memory through a parallel or serial bus.

The controller 420 reads data stored in the memory cluster by cluster, and transfers the read data to the picture frame decoder 430 cluster by cluster. The memory is installed inside or outside of the DVR-integrated display device, and the data stored in the memory may be various types of advertising contents such as multimedia including digital pictures, moving pictures, and music. As described above, when the internal or external memory is connected through the interface unit 410, the controller 420 outputs picture frame data stored in the memory according to an operation command of a user.

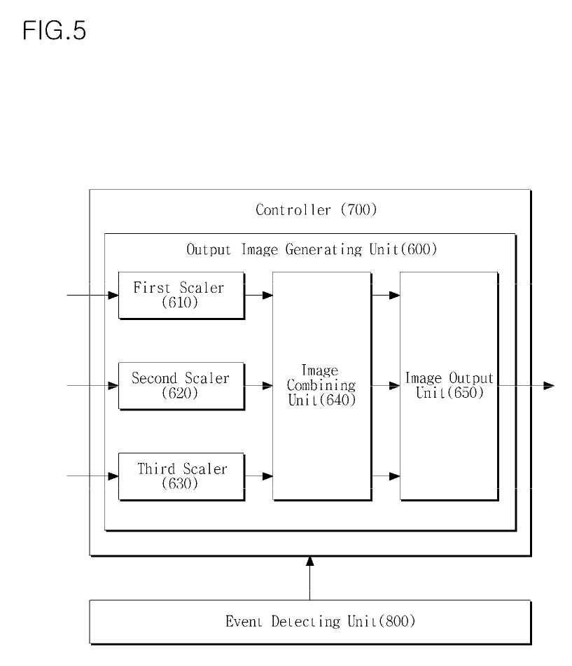

The picture frame decoder 430 reads and decodes the picture frame data output from the controller 420 and outputs the decoded picture frame image to the output image generating unit 600. Accordingly, the output image generating unit 600 outputs an image frame together with either the picture frame or the external image as a PIP picture using the elements shown in FIG. 5.

FIG. 5 is a block diagram of the output image generating unit 600 according to an exemplary embodiment. As shown in FIG. 5, the output image generating unit 600 includes a first scaler 610, a second scaler 620, a third scaler 630, an image combining unit 640, and an image output unit 650.

The first scaler 610 scales an image frame converted by the format converting unit 340 of the recording/reproduction control unit 300.

The second scaler 620 scales an image frame output from the picture frame decoder 430 of the picture frame output unit 400, and the third scaler 630 scales an external image input from the external image output unit 500.

As described above, the external image output unit 500 determines whether the input external image is an analog image or a digital image. When it is determined that the input external image is a digital image, the external image output unit 500 transfers the digital image to the third scaler 630. Alternatively, when it is determined that the external image is an analog image, the external image output unit 500 converts the analog image into a digital image. More specifically, the external image output unit 500 converts an analog image input from a computer or a TV tuner into a digital image in a predetermined format such as YUV and outputs the converted digital image. The digital images output from the external image output unit 500 may be selectively scaled by the third scaler 630.

The above-described first scaler 610, second scaler 620 and third scaler 630 are selectively activated to perform scaling according to a user operation. That is, an image frame, a picture frame, and an external image are scaled by the respective scalers 610, 620, and 630 according to the user operation.

The scaled image frame, picture frame and external image are combined into a PIP picture by the image combining unit 640. In other words, according to the user operation, the image combining unit 640 combines the image frame and the picture frame into a PIP picture, or combines the image frame and the external image into a PIP picture. Subsequently, the image output unit 650 outputs the generated PIP picture on an LCD screen or a monitor screen.

In addition, the image output unit 650 may include a sharpness enhancement circuit and a contrast adjustment function allowing improvement of image quality of the generated PIP picture to be displayed on the LCD screen or the monitor screen.

According to another exemplary embodiment, an event detecting unit 800 may be further included to issue an event detection signal to the control unit 700 when an abnormal event is detected. The event detecting unit 800 may detect any events using, for example, a motion sensor, a door open sensor, and a damage sensor. That is, the event detecting unit 800 issues an event detection signal to the control unit 700 upon detection of an event. In response, the control unit 700 controls the output image generating unit 600 to display an image from the surveillance camera 100 installed in an area where the event is detected on the LCD screen or the monitor screen in full view.

It will now be described how to output images scaled by the first scaler 610, the second scaler 620, and the third scaler 630 when the event detecting unit 800 detects an event.

According to an exemplary embodiment, the output image generating unit 600 outputs the picture frame scaled by the second scaler 620 or the external image scaled by the third scaler 630 according to a user operation on the LCD screen or the monitor screen in full view when there is no event. However, the event detecting unit 800 issues an event detection signal to the control unit 700 upon detection of an event. In response, the control unit 700 controls the output image generating unit 600 such that DVR images taken by the plurality of surveillance cameras 100 are displayed on the LCD screen or the monitor screen in full view. Accordingly, the image combining unit 640 stops the image output unit from outputting the picture frame or the external image. Then, the image combining unit 640 transmits the image frame received from the first scaler 610 to the image outputting unit 650. In response, the image output unit 650 outputs a DVR image multiplexed into the image frames on the LCD screen or the monitor screen in full view. The image output unit 650 can not only output the multiplexed DVR image, but also output only image frames from the surveillance camera 100 at an area where the event is detected on the LCD screen or the monitor screen in full view. As described above, an administrator can monitor events immediately, even when he/she is engaged in other activities using the LCD screen or the monitor screen, for example, watching TV.

According to another exemplary embodiment, when no event is detected, the image combining unit 640 of the output image generating unit 600 combines the picture frame scaled by the second scaler 620 and the image frame scaled by the first scaler 610 according to a user operation such that the picture frame is output as a primary display and the image frame is output as a secondary display. Accordingly, the picture frame is output as the primary display on the LCD screen or the monitor screen, and the DVR image is output as the secondary display. However, when the event detecting unit 800 detects an event, the control unit 700 controls the output image generating unit 600 to output the image frame as the primary display. Consequently, the first scaler 610 scales the multiplexed image frame to fit the size of the primary display, and the second scaler 620 scales the picture frame to fit the size of the secondary display. Furthermore, the first scaler 610 may scale an image frame of an image taken by the surveillance camera 100 at an area where the event occurs to fit the size of the primary display. Then, the image combining unit 640 overlays the scaled image frame and picture frame to combine them, and transmits the combined image to the image output unit 650. Accordingly, the image output unit 650 outputs a PIP picture generated by combining the two images on the LCD screen or the monitor screen.

For example, if an LCD screen is installed at a crowded location such as a subway station, the LCD screen can simultaneously provide advertising contents in a picture frame and DVR images taken by surveillance cameras at locations throughout the station. As such, since the advertising contents and the DVR images taken by the surveillance cameras are displayed simultaneously on an LCD screen, vandalization of the high-priced LCD screen can be avoided.

Additionally, by displaying advertising contents together with DVR images on an LCD screen located in a blind spot where no surveillance camera is installed, potential vandals, thieves, etc. may believe that a surveillance camera is monitoring the area and be deterred from committing crimes.

According to another exemplary embodiment, when there is no event, the image combining unit 640 of the output image generating unit 600 combines the external image scaled by the third scaler 630 and the image frame scaled by the first scaler 610 such that the external image is output as a primary display and the image frame is output as the secondary display. Accordingly, the external image is output as the primary display and the DVR image multiplexed to the image frame is output as the secondary display. However, when the event detecting unit 800 detects the event, the control unit 700 controls the output image generating unit to output the image frame as the primary display. Accordingly, the first scaler 610 scales the multiplexed image frame to fit the size of the primary display and transmits the scaled image frame to the image combining unit 640, and the third scaler 630 scales the external image to fit the size of the secondary display and transmits the scaled external image to the image combining unit 640. Additionally, the first scaler 610 may scale an image frame of an image taken by the surveillance camera 100 installed at an area where the event occurs to fit the size of the primary display. Then, the image combining unit 640 combines the image frame scaled to the size of the primary display and the external image scaled to the size of the secondary display by overlaying the picture frame with the external image. Then, the image combining unit 640 transmits the combined images to the image output unit 650. Accordingly, the image output unit 650 outputs the images combined in a PIP manner on the LCD screen or the monitor screen.

For example, a security guard who manages the coming and going of vehicles watches TV with a primary display of a monitor screen and monitors DVR images taken by surveillance cameras installed on the premises and displayed on a secondary display of the monitor screen. When a vehicle enters the building, a motion sensor detects the motion of the vehicle, and the event detecting unit detects the sensing signal from the motion sensor and issues an event occurrence signal to the control unit 700. In response, the control unit 700 switches the images previously displayed on the primary display and the secondary display with each other. The TV image, previously displayed on the primary display, is output on the secondary display, and the DVR image, previously displayed on the secondary display, is output on the primary display. The DVR image output on the primary display of the monitor screen may be a multiplexed DVR image or a DVR image taken by a surveillance camera located at an area where an event occurs. Since the TV image and the DVR image displayed respectively on the primary display and the secondary display are switched with each other, the security guard can monitor the coming and going vehicles on the monitor screen.

For another example, in a convenience store or a grocery shop, advertisement of new products and a DVR image of an installed surveillance camera can be displayed at the same time through a monitor screen. Thus, new products can be advertised to customers through the monitor screen while DVR images from a surveillance camera deter shoplifting, robbery, etc.

As described above, an administrator can view DVR images output from a surveillance camera, and external images and/or a picture frame output from a computer or a TV tuner, on a single monitor, and switch the images between the primary display and the secondary display according to circumstances. Moreover, the above-described images can be combined as a PIP picture and then displayed on a single monitor screen or an LCD screen.

According to an exemplary embodiment, a DVR-integrated display device with a PIP function allows an administrator to monitor a plurality of sites where surveillance cameras are installed on a single monitor in real time and carry out another activity simultaneously. In addition, a DVR-integrated display device installed in public places can simultaneously provide images taken by a surveillance camera and advertising contents.

For example, in a convenience store, the DVR-integrated display device allows a clerk to monitor customers from images taken by a surveillance camera and displayed on the same monitor which is displaying a TV program. Thus, crimes like theft which could occur while the clerk is distracted by TV can be avoided.

Moreover, the DVR-integrated display device can output advertising contents about new products while displaying DVR images taken by a surveillance camera through a single screen. For example, a high-priced LCD display installed in a crowded place such as a subway station can display advertisements about a plurality of goods and services along with DVR images taken by a surveillance camera to help prevent theft or vandalization of the LCD display.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are possible without departing from the scope of the following claims.

What is claimed is:

1. A digital video recorder (DVR)-integrated display device with a picture-in-picture function, comprising:
an image multiplexing unit outputting an image frame generated by multiplexing an image signal from each of a plurality of cameras or an image frame selected from images from the respective cameras;
a recording/reproduction control unit controlling recording or displaying of an image frame output from the image multiplexing unit;
an output image generating unit outputting the image frame together with a particular image selected by a user operation in a picture-in-picture (PIP) format; and
a control unit comprehensively controlling elements of the display device.

2. The DVR-integrated display device of claim 1, wherein the recording/reproduction control unit includes:
an encoder encoding the image frame received from the image multiplexing unit;
an image storage unit storing the encoded image frame;
a decoder decoding the image frame stored in the image storage unit; and
a format converting unit converting the image frame received from the image multiplexing unit or the image frame decoded by the decoder into a standard format and outputting the converted image frame to the output image generating unit.

3. The DVR-integrated display device of claim 1, further comprising a picture frame output unit including an interface unit, a controller recognizing a memory through the interface unit and controlling an input, and a picture frame decoder decoding picture frame data of the memory and outputting the decoded data to the output image generating unit.

4. The DVR-integrated display device of claim 3, wherein the memory is installed either inside or outside of the DVR-integrated display device and stores various types of advertising contents.

5. The DVR-integrated display device of claim 3, wherein the output image generating unit includes:
a first scaler selectively scaling an image frame output from the recording/reproduction control unit;
a second scaler selectively scaling a picture frame from the picture frame output unit;
an image combining unit combining the image frame scaled by the first scaler and the picture frame scaled by the second scaler into a PIP picture; and
an image output unit outputting the combined image frame generated by the image combining unit on a screen, and
the control unit controls the first scaler, the second scaler and the image combining unit such that a desired PIP picture can be output to the image output unit according to a user operation.

6. The DVR-integrated display device of claim 1, further comprising an external image output unit, when an external image is input, determining whether the input external image is an analog image or a digital image, and when it is determined that the input external image is the analog image, converting the analog image into the digital image and outputting the converted digital image to the output image generating unit,
wherein the external image is a computer image or an image received by a television tuner.

7. The DVR-integrated display device of claim 6, wherein the recording/reproduction control unit includes:
an encoder encoding an image frame received from the image multiplexing unit;
an image storage unit storing the encoded image frame;
a decoder decoding the image frame stored in the image storage unit; and
a format converting unit converting the image frame received from the image multiplexing unit or the image frame decoded by the decoder into a standard format and outputting the converted image frame to the output image generating unit.

8. The DVR-integrated display device of claim 6, wherein the output image generating unit includes:
a first scaler selectively scaling the image frame output from the recording/reproduction control unit;
a third scaler selectively scaling the digital image output from the external image output unit according to a user operation;
an image combining unit combining the image frame scaled by the first scaler and the digital image scaled by the third scaler into a PIP picture; and
an image output unit outputting the combined image frame generated by the image combining unit on a screen, and
the control unit controls the first scaler, the third scaler and the image combining unit such that a desired PIP picture can be output to the image output unit according to a user operation.

9. The DVR-integrated display device of claim 1, further comprising an event detecting unit detecting an abnormal event and transmitting an event detection signal to the control unit,
wherein the output image generating unit outputs a particular image selected by the user, stops outputting the particular image upon detection of the abnormal event, and outputs an image frame output from the image multiplexing unit on the monitor in full view.

10. The DVR-integrated display device of claim 9, wherein the output image generating unit outputs the particular image selected by the user as a primary display, outputs the image frame output from the image multiplexing unit as a secondary display, and, when the event detecting unit detects an abnormal event, outputs the image frame as the primary display and outputs the selected particular image as the secondary display.
